(19) United States
(12) Patent Application Publication
(10) Pub. No.: US 2011/0244241 A1
(43) Pub. Date: Oct. 6, 2011

(54) ADHESION IN ECTFE/POLYESTER CO-EXTRUDED STRUCTURES USING TIE LAYERS

(76) Inventor: Aditya Ranade, Natick, MA (US)

(21) Appl. No.: 13/041,616

(22) Filed: Mar. 7, 2011

Related U.S. Application Data
(60) Provisional application No. 61/311,491, filed on Mar. 8, 2010.

(51) Int. Cl. B32B 27/36; B32B 27/00

(52) U.S. Cl. 428/412; 428/421

(57) ABSTRACT

The invention describes coextruded multi-layer films comprising a first fluoropolymer layer; a second layer comprising a glycidyl acrylate or glycidyl methacrylate or mixtures thereof adhered to the first layer; and a third layer comprising a polyester or polycarbonate adhered to the second layer.

### CROSS REFERENCE TO RELATED APPLICATIONS

This application claims benefit of U.S. Provisional Patent Application Ser. No. 61/311,491 filed on Mar. 8, 2010, entitled “Improving Adhesion in ECTFE/Polyester Co-Extruded Structures Using Tie-Layers,” the contents of which are incorporated in their entirety herein by reference.

### FIELD OF THE INVENTION

The invention relates generally to multilayer fluoropolymer films or laminates, and methods for their manufacture that are useful as packaging materials.

### BACKGROUND OF THE INVENTION

Multilayer films or laminates are constructions, which attempt to incorporate the properties of dissimilar materials in order to provide an improved performance versus the materials separately. Such properties include barrier resistance to elements such as water, cut-through resistance, weathering resistance and/or electrical insulation. Up until the present invention, such laminates often result in a mis-balance of properties, are expensive, or difficult to handle or process. In addition, the inner layers are often not fully protected over the life of the laminate. Sophisticated equipment in the electrical and electronic fields requires that the components of the various pieces of equipment be protected from the effects of moisture and the like. For example, photovoltaic cells and solar panels comprising photovoltaic cells must be protected from the elements, especially moisture, which can negatively impact the function of the cells. In addition, circuit boards used in relatively complicated pieces of equipment such as computers, televisions, radios, telephones, and other electronic devices should be protected from the effects of moisture. In the past, solutions to the problem of moisture utilized metal foils as a vapor or moisture barrier. Metal foils, however, must be insulated from the electronic component to avoid interfering with performance. Previous laminates using metal foils typically displayed a lower level of dielectric strength than was desirable, while other laminates using a metal foil layer were also susceptible to other environmental conditions.

Thin multi-layer films are useful in many applications, particularly where the properties of one layer of the multi-layer film complement the properties of another layer, providing the multi-layer film with properties or qualities that cannot be obtained in a single layer film. Previous multi-layer films provided only one of the two qualities desirable for multi-layer films for use in electronic devices.

A need remains for a multi-layer film that provides an effective barrier to moisture while also providing high dielectric strength or low dielectric constant, and mechanical flexibility.

### BRIEF SUMMARY OF THE INVENTION

The present invention surprisingly provides multi-layer films that overcome one or more of the disadvantages known in the art. These multi-layer films help to protect the components from heat, humidity, chemical, radiation, physical damage and general wear and tear. Such packaging materials help to electrically insulate the active components/circuits of the electronic devices.

The multi-layer films of the invention can be used to protect, in particular, electronic components from moisture, weather, heat, radiation, physical damage and/or insulate the component. Examples of electronic components include, but are not limited to, packaging for crystalline-silicon based thick photovoltaic modules, amorphous silicon, CIGS, or CdTe based thin photovoltaic modules, LEDs, LCDs, printed circuit boards, flexible displays and printed wiring boards. In addition, multilayer fluoropolymer films may be used in other protective applications such as signage covering, aircraft interiors, or other protective covering applications, or even as free standing films such as in greenhouses, awnings and the like.

A further advantage of multi-layer fluoropolymer films is the ability to provide a protective fluoropolymer layer while using a potentially lower cost polymer interior. As such, this may provide an economic advantage.

In one aspect, the present invention provides a coextruded multi-layer film comprising a first fluoropolymer layer; a second layer comprising a glycidyl acrylate or glycidyl methacrylate or mixtures thereof adhered to the first layer; and a third layer comprising a polyester or polycarbonate adhered to the second layer.

In another aspect, the present invention provides a coextruded multi-layer film comprising a first fluoropolymer layer; a second layer adhered to the first layer, comprising a glycidyl acrylate or a glycidyl methacrylate or mixtures thereof; a third layer adhered to the second layer, comprising a polyester or a polycarbonate; a fourth layer adhered to the third layer, comprising a glycidyl acrylate or a glycidyl methacrylate or mixtures thereof; and a fifth layer adhered to the fourth layer, comprising either an encapsulant or a fluoropolymer.

In the various embodiments of the multi-layer films, typical fluoropolymers include PVDF, VDF copolymers, THV, ECTFE and ETFE. Typical polyesters include PET (Polyethylene terephthalate), PEN (Polyethylene Naphthanate), PETg (a copolymer of PET) and PETBB (Polyethylene Terephthalate Bibenzoate). Tie layer materials include glycidyl acrylates or glycidyl methacrylates or mixtures thereof.

The layers used to prepare the multi-layer films of the invention are all melt processable, thus providing an advantage over that of the current art in that typical multistep fabrication is not required (to produce the multi-layer film). Co-extrusion of each layer thus provides that solvent based adhesives, such as polyurethanes, typically required to adhere each layer to each other are not required with the present invention.

It should be understood that the multi-layer films of the invention can include from 2 layers to about 12 layers of material. For example, the multi-layer films can repeat layering of a first layer and a second layer, and so forth.

It is possible that any of the disclosed layers may contain common formulation additives including antioxidants, UV blockers, UV stabilizers, hindered amine stabilizers, curatives, crosslinkers, additional pigments, process aids and the like.

The present invention also provides methods to prepare the multi-layer films noted throughout the specification.

The multilayer films described herein can be considered “backsheet” materials for use with photovoltaic devices as are known in the art.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 depicts one type of 5 layer construct and one type of 4 layer construct described herein.

FIG. 2 provides stability testing of Example 2, a 3 layer construct presented herein.

### DETAILED DESCRIPTION

The present invention provides novel multi-layer films and methods to prepare the multi-layer films by using melt processable materials and coextruding the materials to prepare the multi-layer films. In general the multi-layer films of the invention include a first outer layer comprising a first layer that is either a fluoropolymer or a fluoropolymer (or mixtures thereof) and a glycidyl acrylate or glycidyl methacrylate or mixtures thereof and a second layer that is either a mixture of a polyester or polycarbonate (or both) and a glycidyl acrylate or glycidyl methacrylate or mixtures thereof or a second layer that is a glycidyl acrylate or glycidyl methacrylate or mixtures thereof and a third layer that is a polyester or polycarbonate.

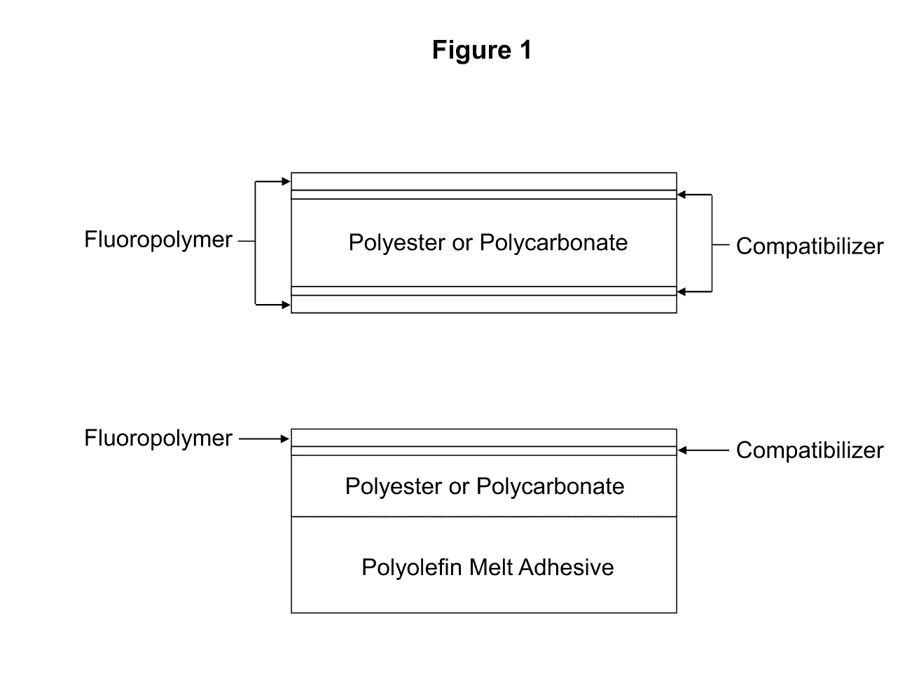

In another embodiment, the multi-layer film is a five (5) layer construct. The construct includes a first layer that is a generally a fluoropolymer or mixtures thereof or a fluoropolymer (or mixtures thereof) and a glycidyl acrylate or glycidyl methacrylate or mixtures thereof. The second layer is a mixture of a polyester or polycarbonate and a glycidyl acrylate or glycidyl methacrylate or mixtures thereof or a second layer that is a glycidyl acrylate or glycidyl methacrylate or mixtures thereof. The third layer is a polyester or a polycarbonate or a mixture thereof. The fourth layer is a mixture of a polyester or a polycarbonate and a glycidyl acrylate or glycidyl methacrylate or mixtures thereof or a layer that is a glycidyl acrylate or glycidyl methacrylate or mixtures thereof and the fifth layer is a fluoropolymer or an encapsulant. FIG. 1 depicts one type of 5 layer construct and one type of 4 layer construct described herein.

For example, in a three layer construct, generally the first layer has a thickness of between about 2 microns (μ) and about 100μ, more particularly between about 5μ, and about 50μ and in particular between about 10μ and about 40μ.

The second layer has a thickness of between about 10 microns (μ) and about 500μ, more particularly between about 50μ and about 300μ and in particular between about 70μ and about 275μ.

The third layer has a thickness of between about 2 microns (μ) and about 500μ, more particularly between about 5μ and about 400μ and in particular between about 10μ and about 200μ.

If the multilayer film is a five layer construct then generally the first layer has a thickness of between about 2 microns (μ) and about 100μ, more particularly between about 5μ and about 50μ and in particular between about 10μ and about 40μ.

The second layer has a thickness of between about 1μ and about 50μ, more particularly between about 2 and about 25μ, and in particular between about 5μ and about 15μ.

The third layer has a thickness of between about 10μ and about 500μ, more particularly between about 50μ and about 300μ and in particular between about 70μ and about 275μ.

The fourth layer has a thickness of between about 1μ and about 50μ, more particularly between about 2 and about 25μ, and in particular between about 5μ and about 15μ.

The fifth layer has a thickness of between about 2μ and about 500μ, more particularly between about 5μ and about 400μ and in particular between about 10μ and about 200μ.

Fillers can be used in one or more of the layers present in the multi-layer film. The multi-layer films of the invention can be used to protect, in particular, electronic components from moisture, weather, heat, radiation, physical damage and/or insulate the component. Examples of electronic components include, but are not limited to, packaging for crystalline-silicon based thick photovoltaic modules, amorphous silicon, CIGS, CdTe based thin photovoltaic modules, LEDs, LCDs, printed circuit boards, flexible displays and printed wiring boards. The multilayer films described herein can be placed adjacent to the electronic component, such as a photovoltaic device. The term “adjacent” is meant to encompass the possibility that the device is in direct contact with the multi-layer film(s) described herein or in indirect contact. In the later, one or more layers of secondary film(s) can separate the multi-layer film(s) described herein (often referred to as a “backsheet”). The secondary film can be an encapsulant such as those known in the art or other film material that separates the photovoltaic device from the backsheet material.

The methods of the invention to prepare the multi-layer films herein provide a couple of surprising advantages over known multi-layer films. First, since co-extrusion of the melt processable materials is utilized, the process itself eliminates multiprocessing steps often required to prepare multi-layer films. Second, most (if not all) multi-layer films require a solvent based adhesive, such as a polyurethane, to affect adhesion between layers. Adhesives are not required with the present invention.

As a consequence of the choice of materials for the multi-layer film, as well as the process to prepare the multi-layer film, the cost of the multi-layer film is decreased relative to known processes and materials.

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

### Fluoropolymers:

Among the classes of polymers, fluoropolymers are unique materials because they exhibit an outstanding range of properties such as high transparency, good dielectric strength, high purity, chemical inertness, low coefficient of friction, high thermal stability, excellent weathering, and UV resistance. Fluoropolymers are frequently used in applications calling for high performance in which oftentimes the combination of the above properties is required. However fluoropolymers are known to transmit UV light to underlying layers and an improved composition is needed to protect underlying materials.

The phrase “fluoropolymer” is known in the art and is intended to include, for example, polytetrafluoroethylene, copolymers of tetrafluoroethylene and hexafluoropropylene, tetrafluoroethylene-perfluoro(alkyl vinyl ether) copolymers (e.g., tetrafluoroethylene-perfluoro(propyl vinyl ether), FEP (fluorinated ethylene propylene copolymers), polyvinyl fluoride, polyvinylidene fluoride, and copolymers of vinyl fluoride, chlorotrifluoroethylene, and/or vinylidene difluoride (i.e., VDF) with one or more ethylenically unsaturated monomers such as alkenes (e.g., ethylene, propylene, butylene, and 1-octene), chloroalkenes (e.g., vinyl chloride and tetrachloroethylene), chlorofluoroalkenes (e.g., chlorotrifluoroethylene), fluoroalkenes (e.g., trifluoroethylene, tetrafluoroethylene (i.e., TFE), 1-hydropentafluoropropene, 2-hydropentafluoropropene, hexafluoropropylene (i.e. HFP), and vinyl fluoride), perfluoroalkoxyalkyl vinyl ethers (e.g., CF₃OCF₂CF₂CF₂OCF═CF₂); perfluoroalkyl vinyl ethers (e.g., CF₃OCF═CF₂ and CF₃C₂CF₂OCF═CF₂), and combinations thereof.

The fluoropolymer can be melt-processable, for example, as in the case of polyvinylidene fluoride; copolymers of vinylidene fluoride; copolymers of tetrafluoroethylene, hexafluoropropylene, and vinylidene fluoride copolymers of tetrafluoroethylene and hexafluoropropylene; copolymers of ethylene and tetrafluoroethylene and other melt-processable fluoroplastics; or the fluoropolymer may not be melt-processable, for example, as in the case of polytetrafluoroethylene, copolymers of TFE and low levels of fluorinated vinyl ethers, and cured fluoroelastomers.

Useful fluoropolymers include copolymers of HFP, TFE, and VDF (i.e., THV). Examples of THV polymers include those marketed by Dyneon, LLC under the trade designations “DYNEON THV”.

Other useful fluoropolymers also include copolymers of ethylene, TFE, and HFP. Such polymers are marketed, for example, under the trade designation “DYNEON FLUOROTHERMOPLASTIC HTE” by Dyneon, LLC.

Additional commercially available vinylidene fluoride-containing fluoropolymers include, for example, those fluoropolymers having the trade designations; “KYNAR” (e.g., “KYNAR 740”) as marketed by Arkema, Philadelphia, Pa.; “HYLAR” (e.g., “HYLAR 700”) and “SOLEF” as marketed by Solvay Solexis USA, West Deptford, N.J.; and “DYNEON PVDF Fluoroplastics” such as DYNEON FP 109/0001 as marketed by Dyneon, LLC. Copolymers of vinylidene difluoride and hexafluoropropylene are also useful. These include for example KYNARFLEX (e.g. KYNARFLEX 2800 or KYNARFLEX 2550) as marketed by Arkema.

Commercially available vinyl fluoride fluoropolymers include, for example, those homopolymers of vinyl fluoride marketed under the trade designation “TEDLAR” by E.I. du Pont de Nemours & Company, Wilmington, Del.

Useful fluoropolymers also include copolymers of tetrafluoroethylene and propylene (TFE/P). Such polymers are commercially available, for example, under the trade designations “AFLAS as marketed by AGC Chemicals America, or “VITON” as marketed by E.I. du Pont de Nemours & Company, Wilmington, Del.

Useful fluoropolymers also include copolymers of ethylene and TFE (i.e., “ETFE”). Such polymers may be obtained commercially, for example, as marketed under the trade designations “DYNEON FLUOROTHERMOPLASTIC ET 6210A”, “DYNEON FLUOROTHERMOPLASTIC ET 6235”, or by Dyneon, LLC, or under the trade designation “NEOFLON ETFE” from Daikin America Inc (e.g. NEOFLON ETFE EP521, EP541, EP543, EP6100R EP620), or under the trade designation “TEFZEL” from E.I. du Pont de Nemours & Company, Wilmington, Del.

Additionally, useful fluoropolymers include copolymers of ethylene and chlorotrifluoroethylene (ECTFE). Commercial examples include Halar 350 and Halar 500 resin from Solvay Solexis Corp.

Other useful fluoropolymers include substantially homopolymers of chlorotrifluoroethylene (PCTFE) such as Aclar from Honeywell.

Modified fluoropolymers, a subgroup of fluoropolymers in general, are also useful. Suitable functional groups attached in modified (functionalized) fluoropolymers are carboxylic acid groups such as maleic or succinic anhydride (hydrolyzed to carboxylic acid groups), carbonates, epoxy, acrylate and its derivative such as methacrylate, phosphoric acid and sulfonic acid. Commercially available modified fluoropolymers include Fluon® LM-ETFE AH from Asahi, Neoflon® EFEP RP5000 and Neoflon® ETFE EP7000 from Daikin and Tefzel®HT2202 from DuPont.

Fluoropolymeric substrates may be provided in any form (e.g., film, tape, sheet, web, beads, particles, or as a molded or shaped article) as long as fluoropolymer can be melt processed.

### Polyesters:

Exemplary polyesters include a polyester derived from a dicarboxylic acid or a lower alkyl ester thereof and a glycol; a polyester obtainable from a hydroxycarboxylic acid, if necessary, with a dicarboxylic acid or a lower alkyl ester thereof and/or a glycol; a polyester derived from a lactone.

The dicarboxylic acid component can include, for example, aliphatic dicarboxylic acids such as glutaric acid, adipic acid, pimelic acid, suberic acid, azelaic acid and sebacic acid; alicyclic dicarboxylic acids such as cyclohexane-1,4-dicarboxylic acid; aromatic dicarboxylic acids such as terephthalic acid, isophthalic acid, phthalic acid, phthalic anhydride, p-.beta.-ethoxybenzoic acid, 2,6-naphthalenedicarboxylic acid, di(p-carboxyphenyl)ketone, di(p-carboxyphenyl)ether, bis(4-carboxyphenyl)ethane and 5-sodiumsulfo isophthalic acid; etc.

Examples of the glycol component, include aliphatic diols such as ethylene glycol, diethylene glycol, polyethylene glycol, propylene glycol, dipropylene glycol, polypropylene glycol, butanediol, polytetramethylene glycol, hexanediol and neopentyl glycol; an alicyclic diol such as a cyclohexanediol; an aromatic diol such as bisphenol A; and an alkylene oxide (e.g. ethylene oxide) adduct of bisphenol A.

Suitable polyesters are, for example, polyethylene terephthalate (PET), polyethylene naphthalate (PEN), polybutylene terephthalate (PBT), polytrimethylene terephthalate (PTT), bibenzene-modified polyethylene terephthalate (PETBB), bibenzene-modified polybutylene terephthalate (PBTBB), bibenzene-modified polyethylene naphthalate (PENBB) or mixtures thereof, PET, PBT, PEN and PPT and mixtures and copolyesters thereof being preferred. For the preparation of the polyesters, isophthalic acid (IPA), trans- and/or cis-1,4-cyclohexanedimethanol (c-CHDM, t-CHDM or c/t-CHDM) and other suitable dicarboxylic acid components (or dicarboxylic esters) and diol components can also be used in addition to the main monomers, such as dimethyl terephthalate (DMT), ethylene glycol (EG), propylene glycol (PG), 1,4-butanediol, terephthalic acid (TA), benzenedicarboxylic acid and/or 2,6-naphthalenedicarboxylic acid (NDA).

Other suitable polyesters are aliphatic polyesters, such as polyhydroxybutyrate (PHB) and its copolymer with polyhydroxyvalerate (PHV), polyhydroxybutyrate-valerate (PHBV), poly(.epsilon.-caprolactone) (PCL), SP 3/6, SP 4/6 (consisting of 1,3-propanediol/adipate or 1,4-butanediol/adipate), polycaprolactam or generally polyesters comprising adipic acid, and the esters of other aliphatic carboxylic acids.

Polyester substrates may be provided in any form (e.g., film, tape, sheet, web, beads, particles, or as a molded or shaped article) as long as material can be melt processed.

### Polycarbonates:

The polycarbonate useful in the invention includes a polymer obtainable by providing a dihydroxy compound to react with phosgene or a carbonic diester such as diphenyl carbonate. The hydroxyl compound can be an alicyclic compound or others but preferably be a bisphenol compound.

Bisphenol compounds include bis(4-hydroxyphenyl)methane, 1,1-bis(4-hydroxyphenyl)ethane, 1,1-bis(4-hydroxyphenyl)propane, hydroxyphenyl)ethane, 1,1-bis(4-hydroxyphenyl)propane, 2,2-bis(4-hydroxyphenyl)propane (hereinafter referred to as bisphenol A), 2,2-bis(4-hydroxyphenyl)butane, 2,2-bis(4-hydroxyphenyl)pentane, 2,2-bis(4-hydroxyphenyl)-3-methylbutane, 2,2-bis(4-hydroxyphenyl)hexane, 2,2-bis(4-hydroxyphenyl)-4-methylpentane, 1,1-bis(4-hydroxyphenyl)cyclopentane, 1,1-bis(4-hydroxyphenyl)cyclohexane, bis(4-hydroxy-3-methylphenyl)methane, 1,1-bis(4-hydroxy-3-methylphenyl)ethane, 2,2-bis(4-hydroxy-3-methylphenyl)propane, 2,2-bis(4-hydroxy-3-ethylphenyl)propane, 2,2-bis(4-hydroxy-3-isopropylphenyl)propane, 2,2-bis(4-hydroxy-3-sec-butylphenyl)propane, bis(4-hydroxyphenyl)phenylmethane, 1,1-bis(4-hydroxyphenyl)-1-phenylethane, 1,1-bis(4-hydroxyphenyl)-1-phenyl propane, bis(4-hydroxyphenyl)diphenylmethane, bis(4-hydroxyphenyl)dibenzylmethane, 4,4′,-dihydroxydiphenyl ether, 4,4′-dihydroxydiphenyl sulfone, 4,4′-dihydroxydiphenyl sulfide, etc. One particular commercially available polycarbonate are polycarbonate copolymers, LEXAN DMX2415 from GE Plastics

Polycarbonate substrates may be provided in any form (e.g., film, tape, sheet, web, beads, particles, or as a molded or shaped article) as long as material can be melt processed.

Polyester and polycarbonate materials are selected for the interior layer due in part to their dielectric properties as they are able to withstand partial discharge and their superior mechanical toughness, impact resistance.

### Tie Materials:

It has been unexpectedly found that certain tie materials, such as glycidyl acrylates or glycidyl methacrylates or mixtures thereof provide surprisingly good adhesive properties between, for example a fluoropolymer layer and a polyester or a polycarbonate layer. Additionally, in certain embodiments, the glycidyl tie material can be admixed with either the fluoropolymer, the polyester (or polycarbonate) or both, further facilitating the layers to adhere to each other. Suitable glycidyl tie materials include epoxide grafted ethylene methacrylates or acrylates (such as those from Arkema, Inc., LOTADER® 8900 series) including EMAC-GMA (ethylene methyl acrylate-glycidyl methacrylate), EBAC-GMA (ethylene methyl acrylate-glycidyl methacrylate), ethylene GMA and propylene GMA.

When mixtures of the glycidyl tie material and a polyester or polycarbonate are utilized, the amount of glycidyl tie material in the mixture (glycidyl tie material:polyester) is from about 0.5 to about 50, more particularly from about 1 to about 40 and most particularly from about 5 to about 39 weight percent. Encapsulants are materials that help protect the photovoltaic device. Generally, they are thermoplastic materials. Such materials include, but are not limited to, for example natural or synthetic polymers including polyethylene (including linear low density polyethylene, low density polyethylene, high density polyethylene, etc.), polypropylene, nylons (polyamides), EPDM, polyesters, polycarbonates, ethylene-propylene elastomer copolymers, copolymers of ethylene or propylene with acrylic or methacrylic acids, acrylates, methacrylates, ethylene-propylene copolymers, poly alpha olefin melt adhesives such including, for example, ethylene vinyl acetate (EVA), ethylene butyl acrylate (EBA) ethylene methyl acrylate (EMA); ionomers (acid functionalized polyolefins generally neutralized as a metal salt), acid functionalized polyolefins, polyurethanes including, for example, TPUs, olefin elastomers, olefinic block copolymers, thermoplastic silicones, polyvinyl butyral or mixtures thereof. Suitable ionomers include, but are not limited to, those known under the tradenames of Surlyn® (DuPont, for example SURLYN PV-4000, or SURLYN 1702) and Iotek® (Exxon Mobil).

Suitable thermoplastic silicones include, but are not limited to those under the tradename Geniomer® (Wacker).

Suitable TPU materials include, but are not limited to those under the tradenames of Elastollan® (BASF), Texin® and Desmopan® (Bayer), Estane® (Lubrizol), Krystalflex®, Krystalgran® Avalon® (Huntsmann)

Polyalpha olefin melt adhesives are known in the art and include, for example, ethylene alpha olefin copolymers such as ethylene vinyl acetate (EVA), ethylene octene, and ethylene propylene.

Suitable polyolefin polymers include but are not limited to ethylene or propylene co-polymers of an C₂₋₂₀ α-olefin, more particularly the α-olefin is selected from the group ethylene, propylene, 1-butene, isobutylene, 1-pentene, 1-heptene, 1-octene, 1-nonene and 1-decene and blends or combinations thereof. Suitable examples include, but are not limited to Tradename examples: Amplify®, Affinity®, Versify®, Engage®, Infuse® (Dow Chemicals), Tafmer® (Mitsui Chemicals), Exact®, Exceed®, Achieve®, Vistamaxx® (Exxon Mobil), Adflex® (Basell), Surpass® (Nova), Notio® (Mitsui).

In particular, suitable PAO hot melt adhesives include ethylene (E)/vinyl acetate (VA) polymers. The ratio of ethylene to vinyl acetate can be controlled and those EVA polymers having a VA content of about 5% to about 40 weight % are particularly useful in this invention. Suitable EVA materials include those available under the tradenames Elvax (Dupont, for example PV 1400 and PV 1410), Ateva (AT Plastics), Evatane (Arkema), or Alcudia (Repsol).

### Fillers:

Suitable fillers include, for example, silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

Typically, when a filler is present in a given layer, it is found in an amount of from about 0.5 to about 50, more particularly from about 1 to about 30 and more particularly from about 2 to about 20 weight percent based on the total weight of the given layer.

Multilayer films of this invention may be formed by a variety of methods including thermal lamination, coextrusion, extrusion coating, and extrusion lamination. Thermal lamination refers the process of contacting two films while applying heat and pressure. Generally this is accomplished by heating at least one of the polymers to or near its softening or melting point. Extrusion coating refers to the process of melting a thermoplastic polymer in a extruder and then passing the molten polymer through a die to control layer thickness and depositing it on a moving substrate. As the polymer cools it solidifies and adheres to the substrate. The rate of cooling may be controlled or accelerated with methods such as chill rolls or air knives The coating may be extruded as a single layer, or as multiple layer by simultaneously extruding multiple layers of polymer through a single die in a process referred to as coextrusion. Extrusion lamination is an alternative embodiment of this process in which a molten polymer is extrusion coated on to a first substrate and then a second substrate is immediately applied to the exposed surface of the molten polymer. The molten polymer adheres the two substrates together as it cools. (See for example, Edward M Petrie, “Adhesion in Extrusion and Coextrusion Processes,” SpecialChem4Adhesives website, Jul. 30, 2008).

The film of polymeric matrix material and particulate filler can be further heated to modify the physical properties of the film. This can include post cure of the film or post processing steps such as stretching, orienting, annealing, embossing and the like.

In another aspect, the present invention provides melt processable compositions useful to prepare the multilayer films of the invention via melt processing techniques such as extrusion, coextrusion, thermal lamination, adhesive lamination, or extrusion lamination.

Methods to prepare the multi-layer films of the invention include cast or blown film extrusion as known in the art. Coextrusion is a particularly advantageous process for the preparation of multi-layer films of the invention. In coextrusion, the layers of the composite are brought together in a coextrusion block as melt layers and then extruded together through a die. In order to produce sheets or films, a slot die, for example, is used during extrusion.

24:1 single screw extruders can be used for the fluoropolymer outer layers. 30:1 single screw extruders with a Barrier Screw can be used for the polyester/polycarbonate core layer. 30:1 single screw extruders can be used for the tie layers and the encapsulant. The melts from these extruders can be combined in a 5 layer feedblock and spread into a film using a single/multi manifold spreader die. A 3 layer stack with a casting drum can be used as a take-off system.

The process is solvent-free and therefore advantageous from an economic and ecological standpoint. The process according to the invention permits the continuous preparation of endless plastics composites and, e.g., during a later manufacture of photovoltaic modules, obviates the separate insertion and polishing of the individual layers in each case (films or sheets).

The co-extruded multilayer films of the invention have excellent properties such as water vapor transmission rate (WVTR), electrical insulation, solar reflectivity and durability to UV, temperature and humidity.

The following paragraphs enumerated consecutively from one (1) through seventy (70) provide for various aspects of the present invention. In one embodiment, in a first paragraph (1), the present invention provides a coextruded multi-layer film comprising:
a first fluoropolymer layer; and
a second layer comprising a mixture of a polyester or a polycarbonate and a glycidyl acrylate or glycidyl methacrylate or mixtures thereof.

2. The coextruded multi-layer film of paragraph 2, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof

3. The coextruded multi-layer film of either of paragraphs 1 or 2, wherein the polyester is PET (Polyethylene terepthalate), PEN (Polyethylene Naphthanate), PETg (a copolymer of PET), PETBB (Polyethylene Terephthalate Bibenzoate) or mixtures thereof

4. The coextruded multi-layer film of either of any of paragraphs 1 through 3, further comprising a third layer adhered to the second layer, wherein the third layer comprises an encapsulant.

5. The coextruded multi-layer film of paragraph 4, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

6. The coextruded multi-layer film of any of paragraphs 1 through 5, further comprising a filler in one or more of the first, second or third layer, if present.

7. The coextruded multi-layer film of paragraph 6, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

8. The coextruded multi-layer film of any of paragraphs 1 through 7, wherein the glycidyl acrylate or glycidyl methacrylate is ethylene-methyl acrylate-glycidyl methacrylate, ethylene-butyl acrylate-glycidyl methacrylate or mixtures thereof

9. A coextruded multi-layer film comprising:
a first fluoropolymer layer;
a second layer comprising a glycidyl acrylate or glycidyl methacrylate or mixtures thereof adhered to the first layer; and
a third layer comprising a polyester or a polycarbonate adhered to the second layer.

10. The coextruded multi-layer film of paragraph 9, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof

11. The coextruded multi-layer film of either of paragraphs 9 or 10, wherein the polyester is PET (Polyethylene terepthalate), PEN (Polyethylene Naphthanate), PETg (a copolymer of PET), PETBB (Polyethylene Terephthalate Bibenzoate) or mixtures thereof

12. The coextruded multi-layer film of either of any of paragraphs 10 through 11, further comprising a fourth layer adhered to the third layer, wherein the fourth layer comprises an encapsulant.

13. The coextruded multi-layer film of paragraph 12, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

14. The coextruded multi-layer film of any of paragraphs 10 through 13, further comprising a filler in one or more of the first, second, third or fourth layer, if present.

15. The coextruded multi-layer film of paragraph 14, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof

16. The coextruded multi-layer film of any of paragraphs 10 through 15, wherein the glycidyl acrylate or glycidyl methacrylate is ethylene-methyl acrylate-glycidyl methacrylate, ethylene-butyl acrylate-glycidyl methacrylate or mixtures thereof

17. A coextruded multi-layer film comprising:
a first fluoropolymer layer comprising a mixture of a fluoropolymer and a glycidyl acrylate or glycidyl methacrylate or mixtures thereof; and
a second layer comprising a polyester or a polycarbonate.

18. The coextruded multi-layer film of paragraph 17, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof

19. The coextruded multi-layer film of either of paragraphs 17 or 18, wherein the polyester is PET (Polyethylene terepthalate), PEN (Polyethylene Naphthanate), PETg (a copolymer of PET) and PETBB (Polyethylene Terephthalate Bibenzoate), or mixtures thereof.

20. The coextruded multi-layer film of either of any of paragraphs 17 through 19, further comprising a third layer adhered to the second layer, wherein the third layer comprises an encapsulant.

21. The coextruded multi-layer film of paragraph 20, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

22. The coextruded multi-layer film of any of paragraphs 17 through 21, further comprising a filler in one or more of the first, second or third layer, if present.

23. The coextruded multi-layer film of paragraph 22, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

24. The coextruded multi-layer film of any of paragraphs 17 through 23, wherein the glycidyl acrylate or glycidyl methacrylate is ethylene-methyl acrylate-glycidyl methacrylate, ethylene-butyl acrylate-glycidyl methacrylate or mixtures thereof.

25. A coextruded multi-layer film comprising:
a first fluoropolymer layer comprising a mixture of a fluoropolymer and a glycidyl acrylate or glycidyl methacrylate or mixtures thereof; and
a second layer comprising a mixture of a polyester or a polycarbonate and a glycidyl acrylate or glycidyl methacrylate or mixtures thereof.

26. The coextruded multi-layer film of paragraph 25, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

27. The coextruded multi-layer film of either of paragraphs 25 or 26, wherein the polyester is PET (Polyethylene terepthalate), PEN (Polyethylene Naphthanate), PETg (a copolymer of PET) and PETBB (Polyethylene Terephthalate Bibenzoate), or mixtures thereof.

28. The coextruded multi-layer film of either of any of paragraphs 25 through 27, further comprising a third layer adhered to the second layer, wherein the third layer comprises an encapsulant.

29. The coextruded multi-layer film of paragraph 28, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

30. The coextruded multi-layer film of any of paragraphs 25 through 29, further comprising a filler in one or more of the first, second or third layer, if present.

31. The coextruded multi-layer film of paragraph 30, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

32. The coextruded multi-layer film of any of paragraphs 25 through 31, wherein the glycidyl acrylate or glycidyl methacrylate is ethylene-methyl acrylate-glycidyl methacrylate, ethylene-butyl acrylate-glycidyl methacrylate or mixtures thereof

33. A coextruded multi-layer film comprising:
a first fluoropolymer layer;
a second layer comprising a glycidyl acrylate or glycidyl methacrylate or mixtures thereof adhered to the first layer; and
a third layer comprising a mixture of a polyester or a polycarbonate and a glycidyl acrylate or a glycidyl methacrylate or mixtures thereof adhered to the second layer.

34. The coextruded multi-layer film of paragraph 33, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

35. The coextruded multi-layer film of either of paragraphs 33 or 34, wherein the polyester is PET (Polyethylene terepthalate), PEN (Polyethylene Naphthanate), PETg (a copolymer of PET), PETBB (Polyethylene Terephthalate Bibenzoate) or mixtures thereof.

36. The coextruded multi-layer film of either of any of paragraphs 33 through 35, further comprising a fourth layer adhered to the third layer, wherein the fourth layer comprises an encapsulant.

37. The coextruded multi-layer film of paragraph 36, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

38. The coextruded multi-layer film of any of paragraphs 33 through 37, further comprising a filler in one or more of the first, second, third or fourth layer, if present.

39. The coextruded multi-layer film of paragraph 38, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

40. The coextruded multi-layer film of any of paragraphs 33 through 39, wherein the glycidyl acrylate or glycidyl methacrylate is ethylene-methyl acrylate-glycidyl methacrylate, ethylene-butyl acrylate-glycidyl methacrylate or mixtures thereof.

41. A coextruded multi-layer film comprising:
a first fluoropolymer layer comprising a mixture of a fluoropolymer and a glycidyl acrylate or glycidyl methacrylate or mixtures thereof;
a second layer comprising a glycidyl acrylate or glycidyl methacrylate or mixtures thereof adhered to the first layer; and
a third layer comprising a polyester or a polycarbonate adhered to the second layer.

42. The coextruded multi-layer film of paragraph 41, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

43. The coextruded multi-layer film of either of paragraphs 41 or 42, wherein the polyester is PET (Polyethylene terepthalate), PEN (Polyethylene Naphthanate), PETg (a copolymer of PET), PETBB (Polyethylene Terephthalate Bibenzoate) or mixtures thereof.

44. The coextruded multi-layer film of either of any of paragraphs 41 through 43, further comprising a fourth layer adhered to the third layer, wherein the fourth layer comprises an encapsulant.

45. The coextruded multi-layer film of paragraph 44, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

46. The coextruded multi-layer film of any of paragraphs 41 through 45, further comprising a filler in one or more of the first, second, third or fourth layer, if present.

47. The coextruded multi-layer film of paragraph 46, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

48. The coextruded multi-layer film of any of paragraphs 41 through 47, wherein the glycidyl acrylate or glycidyl methacrylate is ethylene-methyl acrylate-glycidyl methacrylate, ethylene-butyl acrylate-glycidyl methacrylate or mixtures thereof.

49. A coextruded multi-layer film comprising:
a first fluoropolymer layer comprising a mixture of a fluoropolymer and a glycidyl acrylate or glycidyl methacrylate or mixtures thereof;
a second layer comprising a glycidyl acrylate or glycidyl methacrylate or mixtures thereof adhered to the first layer; and
a third layer comprising a mixture of a polyester or a polycarbonate and a glycidyl acrylate or a glycidyl methacrylate or mixtures thereof adhered to the second layer.

50. The coextruded multi-layer film of paragraph 49, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

51. The coextruded multi-layer film of either of paragraphs 49 or 50, wherein the polyester is PET (Polyethylene terepthalate), PEN (Polyethylene Naphthanate), PETg (a copolymer of PET), PETBB (Polyethylene Terephthalate Bibenzoate) or mixtures thereof.

52. The coextruded multi-layer film of either of any of paragraphs 49 through 51, further comprising a fourth layer adhered to the third layer, wherein the fourth layer comprises an encapsulant.

53. The coextruded multi-layer film of paragraph 52, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

54. The coextruded multi-layer film of any of paragraphs 49 through 53, further comprising a filler in one or more of the first, second, third or fourth layer, if present.

55. The coextruded multi-layer film of paragraph 54, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

56. The coextruded multi-layer film of any of paragraphs 49 through 55, wherein the glycidyl acrylate or glycidyl methacrylate is ethylene-methyl acrylate-glycidyl methacrylate, ethylene-butyl acrylate-glycidyl methacrylate or mixtures thereof.

57. A coextruded multi-layer film comprising:
a first fluoropolymer layer;
a second layer adhered to the first layer, comprising a glycidyl acrylate or a glycidyl methacrylate or mixtures thereof;
a third layer adhered to the second layer, comprising a polyester or a polycarbonate second layer;
a fourth layer adhered to the third layer, comprising a glycidyl acrylate or a glycidyl methacrylate or mixtures thereof; and
a fifth layer adhered to the fourth layer, comprising either an encapsulant or a fluoropolymer.

58. The coextruded multi-layer film of paragraph 57, wherein the fluoropolymer of the first layer and fifth layer, if present, is each individually selected from polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

59. The coextruded multi-layer film of either of paragraphs 57 or 58, wherein the polyester is PET (Polyethylene terepthalate), PEN (Polyethylene Naphthanate), PETg (a copolymer of PET), PETBB (Polyethylene Terephthalate Bibenzoate) or mixtures thereof.

60. The coextruded multi-layer film of paragraph 57, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

61. The coextruded multi-layer film of any of paragraphs 57 through 60, further comprising a filler in one or more of the first, second, third, fourth or fifth layer.

62. The coextruded multi-layer film of paragraph 61, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

63. The coextruded multi-layer film of any of paragraphs 57 through 62, wherein the glycidyl acrylate or glycidyl methacrylate of the second and fourth layers is selected independently from ethylene-methyl acrylate-glycidyl methacrylate, ethylene-butyl acrylate-glycidyl methacrylate or mixtures thereof.

64. A coextruded multi-layer film comprising:
a first fluoropolymer layer;
a second layer adhered to the first layer, comprising a glycidyl acrylate or a glycidyl methacrylate or mixtures thereof;
a third layer adhered to the second layer comprising a glycidyl acrylate or a glycidyl methacrylate or mixtures thereof and a polyester or a polycarbonate;
a fourth layer adhered to the third layer, comprising a glycidyl acrylate or a glycidyl methacrylate or mixtures thereof; and
a fifth layer adhered to the fourth layer, comprising either an encapsulant or a fluoropolymer.

65. The coextruded multi-layer film of paragraph 64, wherein the fluoropolymer of the first layer and fifth layer, if present, is each individually selected from polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

66. The coextruded multi-layer film of either of paragraphs 64 or 65, wherein the polyester is PET (Polyethylene terephthalate), PEN (Polyethylene Naphthanate), PETg (a copolymer of PET), PETBB (Polyethylene Terephthalate Bibenzoate) or mixtures thereof.

67. The coextruded multi-layer film of paragraph 64, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

68. The coextruded multi-layer film of any of paragraphs 64 through 67, further comprising a filler in one or more of the first, second, third, or fourth or fifth layer.

69. The coextruded multi-layer film of paragraph 61, wherein the filler in each layer, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

70. The coextruded multi-layer film of any of paragraphs 64 through 69, wherein the glycidyl acrylate or glycidyl methacrylate of the second, third and fourth layers is selected independently from ethylene-methyl acrylate-glycidyl methacrylate, ethylene-butyl acrylate-glycidyl methacrylate or mixtures thereof.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Example 1

(ECTFE+14 wt % TiO₂)/EMAC-GMA(ethylene methyl acrylate-glycidyl methacrylate)/PETg (polyethylene terephthalate) 25/12/125 μm

Three 1″ extruders with L:D ratios of 24:1, 24:1, 30:1

Single manifold feedblock and Coathanger Die from EDI Corporation.

Temperatures

ECTFE—200, 220, 240, 240, 240° C. (five zones of the extruder).

EMAC-GMA—150, 180, 210, 210, 210° C. (five zones of extruder)

PETg—230, 250, 240, 240, 240° C. (five zones of extruder)

Feedblock and Die—230° C.

Interlayer Adhesion—8 N/cm Measured by a T-peel test. Te tensile mode was carried out using the universal testing machine from Instron Corp. A strain rate of 50 mm/min was used. Peel strength vs strain was plotted and interlayer adhesion was recorded as the maximum peel strength before breakage or delamination.

### Example 2

(ECTFE+5 wt % TiO₂)/EBAC-GMA (ethylene-butyl acrylate-glycidyl methacrylate)/(PETg+8 wt % TiO₂) 50/25/175 μm

Three 1″ extruders with L:D ratios of 24:1, 24:1, 30:1

Single manifold feedblock and Coathanger Die

Temperatures

ECTFE—200, 220, 240, 240, 240° C.

EBAC-GMA—150, 180, 210, 210, 210° C.

PETg—230, 250, 240, 240, 240° C.

Feedblock and Die—230° C.

Interlayer Adhesion—11 N/cm

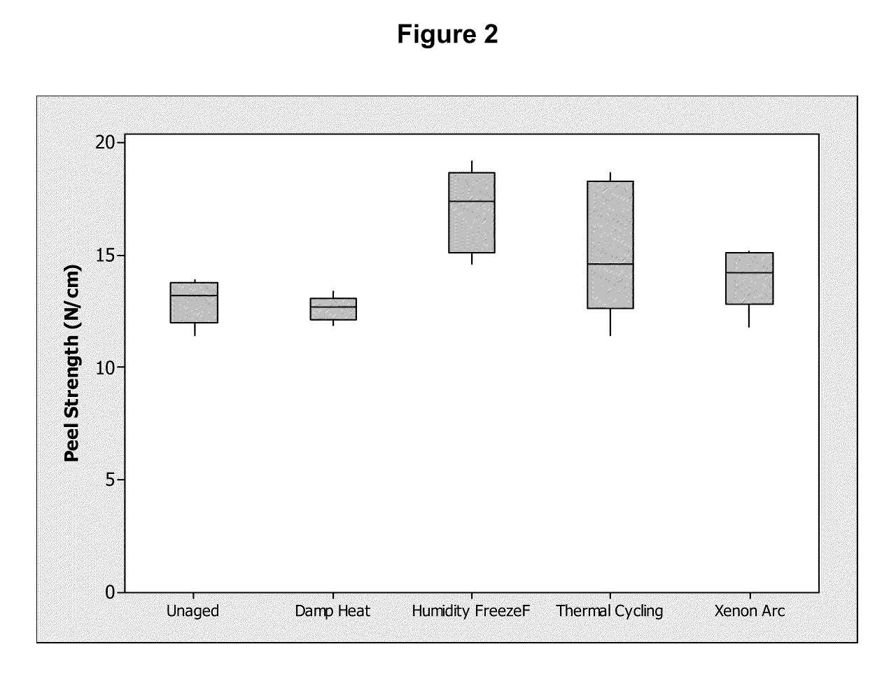

The effect of accelerated aging on interlayer adhesion was probed. The aging conditions are described in the following paragraphs and results are presented in FIG. 2.

Damp Heat—exposure to 85° C., 85% Relative Humidity for 2000 hours, per IEC 61215.

Humidity Freeze—10 cycles consisting each of 20 hour exposure to 85° C., 85% relative humidity followed by a drop to −40° C., per IEC 61215.

Thermal Cycling—200 cycles between 85° C. to −40° C. with no humidity control, per IEC 61215.

Xenon Arc—exposure to Xenon Arc UV aging per ASTM G155.

The results surprisingly show that the PET layer remained well adhered to the fluoropolymer surface even under severe test conditions with the use of the EBAC-GMA tie layer.

### Example 3

(ECTFE+14 wt % TiO₂)/EBAC-GMA/LDPE 25/12/125 μm

Three 1″ extruders with L:D ratios of 24:1, 24:1, 30:1

Single manifold feedblock and Coathanger Die

Temperatures

ECTFE—200, 220, 240, 240, 240° C.

EBAC-GMA—150, 180, 210, 210, 210° C.

LDPE—150, 200, 230, 230, 230° C.

Feedblock and Die—230° C.

Interlayer Adhesion—5 N/cm

### Example 4

ECTFE/ETFE-g-MA/PETg 25/12/125 μm

Three 1″ extruders with L:D ratios of 24:1, 24:1, 30:1

Single manifold feedblock and Coathanger Die

Temperatures

ECTFE—200, 220, 250, 250, 250 deg C.

ETFE-g-MA—200, 270, 300, 300, 300 deg C.

PETg—230, 250, 240, 240, 240 deg C.

Feedblock and Die—250 deg C.

Interlayer Adhesion—1.5 N/cm

### Example 5

ECTFE/PETg 25/125 μm

Two 1″ extruders with L:D ratios of 24:1, 30:1

Single manifold feedblock and Coathanger Die

Temperatures

ECTFE—200, 220, 240, 240, 240° C.

PETg—230, 250, 240, 240, 240° C.

Feedblock and Die—240° C.

Interlayer Adhesion—0.5 N/cm

### Example 6

(ECTFE+14 wt % TiO₂)/EBAC-GMA/PETg/EBAC-GMA/(ECTFE+14 wt % TiO₂) 25/12/250/12/25 μm

| Property | |
|---|---|
| WVTR (g/m2 · day), ASTMF1249 | 1.6 |
| @38° C., 100% RH | |
| Dielectric Breakdown Voltage (kV), | >25, DC |
| ASTM D3755 | |
| Partial Discharge Maximum System | 993 |
| Voltage, IEC 61730-2 | |
| Tensile Strength (MPa), MD/TD | 135/105 |
| Elongation at break (%) MD/TD | 280/170 |
| Interlayer Adhesion (N/cm) | 13 |
| Adhesion to EVA (N/cm) | 82 |
| Solar Reflectivity (%), n = 2 | 85 |
| ASTM E424 | |

Three 1″ extruders with L:D ratios of 24:1, 24:1, 30:1

Single manifold ABCBA feedblock and Coathanger Die (commercially available from EDI Corp and Cloeren Corp)

Temperatures

ECTFE—200, 220, 240, 240, 240° C.

EBAC-GMA—150, 180, 210, 210, 210° C.

PETg—230, 250, 240, 240, 240° C.

Feedblock and Die—230° C.

Interlayer Adhesion—13 N/cm

Although the present invention has been described with reference to preferred embodiments, persons skilled in the art will recognize that changes may be made in form and detail without departing from the spirit and scope of the invention.

All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A coextruded multi-layer film comprising:
a first fluoropolymer layer;
a second layer comprising a glycidyl acrylate or glycidyl methacrylate or mixtures thereof adhered to the first layer; and
a third layer comprising a polyester or a polycarbonate adhered to the second layer.

2. The coextruded multi-layer film of claim 1, wherein the fluoropolymer is a polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

3. The coextruded multi-layer film of claim 1, wherein the polyester is PET (Polyethylene terepthalate), PEN (Polyethylene Naphthanate), PETg (a copolymer of PET), PETBB (Polyethylene Terephthalate Bibenzoate) or mixtures thereof.

4. The coextruded multi-layer film of claim 2, further comprising a fourth layer adhered to the third layer, wherein the fourth layer comprises an encapsulant.

5. The coextruded multi-layer film of claim 5, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

6. The coextruded multi-layer film of claim 5, further comprising a filler in one or more of the first, second, third or fourth layer, if present.

7. The coextruded multi-layer film of claim 1, wherein the glycidyl acrylate or glycidyl methacrylate is ethylene-methyl acrylate-glycidyl methacrylate, ethylene-butyl acrylate-glycidyl methacrylate or mixtures thereof.

8. The coextruded multi-layer film of claim 1, wherein the third layer further comprises a mixture of a polyester or a polycarbonate and a glycidyl acrylate or a glycidyl methacrylate or mixtures thereof adhered to the second layer.

9. The coextruded multi-layer film of claim 1, wherein the first layer comprises a mixture of a fluoropolymer and a glycidyl acrylate or glycidyl methacrylate or mixtures thereof.

10. The coextruded multi-layer film of claim 1, wherein the first fluoropolymer layer comprises a mixture of a fluoropolymer and a glycidyl acrylate or glycidyl methacrylate or mixtures thereof; and
the third layer comprises a mixture of a polyester or a polycarbonate and a glycidyl acrylate or a glycidyl methacrylate or mixtures thereof adhered to the second layer.

11. A coextruded multi-layer film comprising:
a first fluoropolymer layer;
a second layer adhered to the first layer, comprising a glycidyl acrylate or a glycidyl methacrylate or mixtures thereof;
a third layer adhered to the second layer, comprising a polyester or a polycarbonate second layer;
a fourth layer adhered to the third layer, comprising a glycidyl acrylate or a glycidyl methacrylate or mixtures thereof; and
a fifth layer adhered to the fourth layer, comprising either an encapsulant or a fluoropolymer.

12. The coextruded multi-layer film of claim 11, wherein the fluoropolymer of the first layer and fifth layer, if present, is each individually selected from polyvinylidene fluoride (PVDF), fluorinated ethylene propylene copolymers (FEP), copolymers of ethylene and chlorotrifluoroethylene (ECTFE), copolymers of ethylene and trifluoroethylene (ETFE), copolymers of hexafluoropropylene (HFP), trifluoroethylene (TFE), and vinylidene difluoride(VDF) (THV) or mixtures thereof.

13. The coextruded multi-layer film of claim 12, wherein the polyester is PET (Polyethylene terepthalate), PEN (Polyethylene Naphthanate), PETg (a copolymer of PET), PETBB (Polyethylene Terephthalate Bibenzoate) or mixtures thereof.

14. The coextruded multi-layer film of claim 12, wherein the encapsulant is selected from a polyethylene, a polypropylene, a nylon, EPDM, polyesters, polycarbonates, ethylene-propylene elastomer copolymers, polystyrene, ethylene-styrene copolymers, terpolymers of ethylene-styrene and other C3-C20 olefins, copolymers of ethylene or propylene with acrylic or methacrylic acids, acrylates, methacrylates, ethylene-propylene copolymers, ethylene vinyl acetate (EVA), ethylene butyl acrylate (EBA) ethylene methyl acrylate (EMA), ionomers, acid functionalized polyolefins, polyurethanes, olefin elastomers, thermoplastic silicones, polyvinyl butyral or mixtures thereof.

15. The coextruded multi-layer film of claim 12, further comprising a filler in one or more of the first, second, third, fourth or fifth layer.

16. The coextruded multi-layer film of claim 12, wherein the glycidyl acrylate or glycidyl methacrylate of the second and fourth layers is selected independently from ethylene-methyl acrylate-glycidyl methacrylate, ethylene-butyl acrylate-glycidyl methacrylate or mixtures thereof.

17. The coextruded multi-layer film of claim 6, wherein the filler, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.

18. The coextruded multi-layer film of claim 15, wherein the filler, if present, is independently selected from silica, glass beads, glass microspheres, glass fibers, titanium dioxide, barium titanate, calcium carbonate, zinc oxide, cuprous oxide, cupric oxide, aluminum trihydrate, sodium borate hydrate, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated and chlorinated compounds or mixtures thereof.
